(19) United States
(12) Patent Application Publication
(10) Pub. No.: US 2026/0229377 A1
(43) Pub. Date: Aug. 6, 2026

(54) STACKABLE FUEL BLOCK AND METHOD OF CONSTRUCTING SAME

(71) Applicant: Westinghouse Electric Company LLC, Cranberry Township, PA (US)

(72) Inventors: Michael E. Conner, Waukesha, WI (US); Yuriy Aleshin, Franklinton, NC (US); Mykola Boychenko, Seven Fields, PA (US)

(73) Assignee: Westinghouse Electric Company LLC, Cranberry Township, PA (US)

(21) Appl. No.: 19/047,502

(22) Filed: Feb. 6, 2025

(51) Int. Cl. G21C 3/334; G21C 3/16; G21C 21/02

(52) U.S. Cl. CPC G21C 3/334; G21C 3/16; G21C 21/02

(57) ABSTRACT

A method of manufacturing a stackable fuel block may include: forming, using three-dimensional (3D) printing, a first structure as a single piece of non-fissile material, wherein forming the first structure includes: forming, using the 3D printing, a plurality of channels configured to receive guide thimbles and/or instrument tubes; forming, using the 3D printing, a plurality of fissile material enclosures including a top fuel cap and a bottom fuel cap, where the fissile material enclosures are configured to enclose fissile material; and forming, using the 3D printing, a plurality of enclosure connectors, each enclosure connector extending between adjacent fissile material enclosures. The method may further include disposing fissile material inside the plurality of fissile material enclosures.

### BACKGROUND

Current nuclear fuel assemblies used in nuclear power plants, for example pressurized water reactors (PWR), typically consist of 12- to 14-foot-long fuel rods held contained by top and bottom nozzles and supported by various types of spacer grids. Past and current fuel assembly configurations are limited by existing manufacturing methods proven in other industries. Presently, these methods and the assemblies produced by these methods use many individual parts. There exists a need to reduce the number of individual parts required in nuclear fuel assemblies and a need to reduce or eliminate rod bow and the associated rod bow departure from the nucleate boiling (DNB) penalty, grid-to rod fretting failure, fuel assembly distortion and its consequences (handling damages and incomplete control rod insertions among others).

### SUMMARY

The following summary is provided to facilitate an understanding of some of the innovative features unique to the aspects disclosed herein and is not intended to be a full description. A full appreciation of the various aspects can be gained by taking the entire specification, claims, and abstract as a whole.

In a first embodiment, a method of manufacturing a stackable fuel block is disclosed. The method may include: forming, using three-dimensional (3D) printing, a first structure as a single piece of non-fissile material, wherein forming the first structure comprises: forming, using the 3D printing, a plurality of channels configured to receive guide thimbles and/or instrument tubes; forming, using the 3D printing, a plurality of fissile material enclosures including a top fuel cap and a bottom fuel cap, wherein the fissile material enclosures are configured to enclose fissile material; and forming, using the 3D printing, a plurality of enclosure connectors, each enclosure connector extending between adjacent fissile material enclosures. The method may further include disposing fissile material inside the plurality of fissile material enclosures.

In a second embodiment, a fuel assembly comprising a plurality of stackable fuel blocks is disclosed. Each fuel block may include: a 3D-printed single piece comprising a first material, the 3D-printed single piece further comprising: a plurality of 3D-printed channels configured to receive guide thimbles and/or instrument tubes; a plurality of 3D-printed fissile material enclosures including a top fuel cap and a bottom fuel cap and configured to enclose fissile material; and a plurality of 3D-printed enclosure connectors, each 3D-printed enclosure connector disposed at a top end or a bottom end of the 3D-printed fissile material enclosures and connecting adjacent 3D-printed fissile material enclosures. Each fuel block may also include the fissile material disposed in each fissile material enclosure, each of the plurality of stackable fuel blocks being stackable with another stackable fuel block top to bottom in a complementary manner.

### BRIEF DESCRIPTION OF THE DRAWINGS

Various features of the aspects described herein are set forth with particularity in the appended claims. The various aspects, however, both as to organization and methods of operation, together with advantages thereof, may be understood in accordance with the following description taken in conjunction with the accompanying drawings as follows.

FIG. 1A presents a front view of a thimble guide assembly in accordance with embodiments of the present disclosure.

FIGS. 1B and 1C present front views of varying horizontal magnification of a fuel assembly in accordance with embodiments of the present disclosure.

FIGS. 2A and 2B present a perspective view and a sectional view of vaneless fuel block without an outer strap, respectively, in accordance with embodiments of the present disclosure.

FIGS. 3A and 3B present a perspective view and a sectional view of vaneless fuel block with an outer strap, respectively, in accordance with embodiments of the present disclosure.

FIGS. 4A and 4B present a perspective view and a sectional view of vaned fuel block with an outer strap, respectively, in accordance with embodiments of the present disclosure.

FIGS. 5A and 5B present a perspective view and a sectional view of vaned fuel block to guide thimble interface, respectively, in accordance with embodiments of the present disclosure.

FIG. 6 presents a perspective view of an enclosure connection in accordance with embodiments of the present disclosure.

FIG. 7 presents a perspective view of a crate with vane in accordance with embodiments of the present disclosure.

FIGS. 8A-8C present a perspective view, a sectional view, and a section perspective view of a channel for fissile material, respectively, in accordance with embodiments of the present disclosure.

FIG. 9 presents a sectional view of fissile material encapsulated in a fissile material enclosure in accordance with embodiments of the present disclosure.

FIG. 10 is a flowchart of a method in accordance with embodiments of the present disclosure.

Corresponding reference characters indicate corresponding parts throughout the several views. The exemplifications set out herein illustrate various aspects of the disclosure, in one form, and such exemplifications are not to be construed as limiting the scope of the disclosure in any manner.

### DETAILED DESCRIPTION

Numerous specific details are set forth to provide a thorough understanding of the overall structure, function, manufacture, and use of the aspects as described in the disclosure and illustrated in the accompanying drawings. Well-known operations, components, and elements have not been described in detail so as not to obscure the aspects described in the specification. The reader will understand that the aspects described and illustrated herein are non-limiting examples, and thus it can be appreciated that the specific structural and functional details disclosed herein may be representative and illustrative. Variations and changes thereto may be made without departing from the scope of the claims. Furthermore, it is to be understood that such terms as "forward", "rearward", "left", "right", "upwardly", "downwardly", and the like are words of convenience and are not to be construed as limiting terms.

In the following description, reference characters designate like or corresponding parts throughout the several views of the drawings. Also in the following description, it is to be understood that such terms as "forward", "rearward", "left", "right", "upwardly", "downwardly", and the like are words of convenience and are not to be construed as limiting terms.

With the evolution of additive manufacturing (AM) technologies, also referred to as three-dimensional (3D) printing, limitations noted above are being made obsolete. The development of AM systems for use in reactor systems, specifically fuel assemblies, allows 3D printing of a design with the same basic geometry of current PWR but with advantages over the current PWR fuel such as improvements versus current PWR fuel including reduction in the total number of parts, reduction or elimination of rod bow and the associated rod bow departure from the nucleate boiling (DNB) penalty, grid-to-rod fretting failure, fuel assembly distortion and its consequences (handling damages and incomplete control rod insertions among others).

During DNB, a local vapor layer forms out the outside of the cladding containing fissile material (i.e., nuclear fuel) resulting in a significant reduction in cooling ability of the circulating coolant, potentially a critical safety issue for a nuclear reactor.

In some embodiments, a fuel assembly utilizes short (up to one foot) interfacing segments consisting of fissile material and fissile material enclosure. These fuel segments can be additively manufactured (i.e., 3D printing) allowing each segment to be built independently of the others. The fuel assembly may keep the same fuel rod outer diameter and fuel rod pitch as current PWR fuel. Therefore, hydraulic compatibility with existing PWR fuel designs can be maintained.

The use of additive manufacturing for use in nuclear reactors, specifically fuel assemblies, may improve fuel management, support more challenging operating conditions (uprates), reduce or eliminate performance issues such as fretting, debris, or PCI and address licensing concerns such as fuel fragmentation, relocation, and dispersal (FFRD), zirconium-steam reactions in accident conditions (if Zirconium alloy is not used as an enclosure material), and the like.

To enable use of embodiments of the fuel assembly in existing PWR plants, this segmented, stackable fuel assembly utilizes the conventional skeleton with the top and bottom nozzles connected by the required number of guide thimbles, instrument tube and corresponding joint connections. The fit and form of the skeleton corresponds to the selected fuel type to be replaced. The stack of fuel segments consists of a number of interfacing segments positioning by the guide thimbles and interfacing features. A stackable fuel block includes the fissile material enclosure, the fissile material, and the grid.

The fissile material enclosure is a thin-wall structure that takes the same geometry (specifically outer diameter) as current fuel rods. The fissile material enclosure provides a barrier between fissile material and coolant. Depending on fuel management and operating conditions, as well as required performance benefits, the fissile material enclosure material and thickness could be selected from several different alloys. For example, Zr based material or FeCrAl could be used to build the fissile material enclosure. Use of the same fuel rod pitch and fuel rod outer diameter as current PWR fuel will allow for many existing models, methods, and codes to be used for embodiments of the stackable fuel blocks.

The fuel block grid is designed to provide the same functions as the current structural grids in PWR fuel: provide axial and lateral support of the "fuel rods," provide the fuel rod pitch, include mixing vanes to mix the flow and maintain DNB performance. Due to the AM printing process, unique mixing vane shapes could be used that would not be able to be put on traditional PWR grids.

The fuel block grid has been shown to have a similar or a lower pressure drop that the traditional PWR grids which had springs and dimples. This potential reduction in pressure drop can be used to add additional mixing vanes to improve heat transfer during normal operation, transient conditions, and accidents and improve DNB performance.

AM printing of the fuel block design may include printing of the grids and "fuel rods" as one structure. In one or more embodiments, the fissile material may be manufactured at the same time as the "rod rods" with the fissile material inside the "fuel rods", Porosity or voids may be introduced in the fissile material to mitigate expected swelling.

In one or more embodiments, printing the grid and the fuel rods (or fissile material enclosures and/or fissile material) together may reduce or eliminate fuel rod bow in PWR fuel and the associated rod bow departure from the nucleate boiling (DNB) penalty, grid-to-rod fretting failure, fuel assembly distortion and its consequences (handling damages, incomplete control rod insertions, etc.). The printing the grid and the fuel rod allows to create a solid ligament connection between grid and fuel rod such that no gap opening is possible during operation.

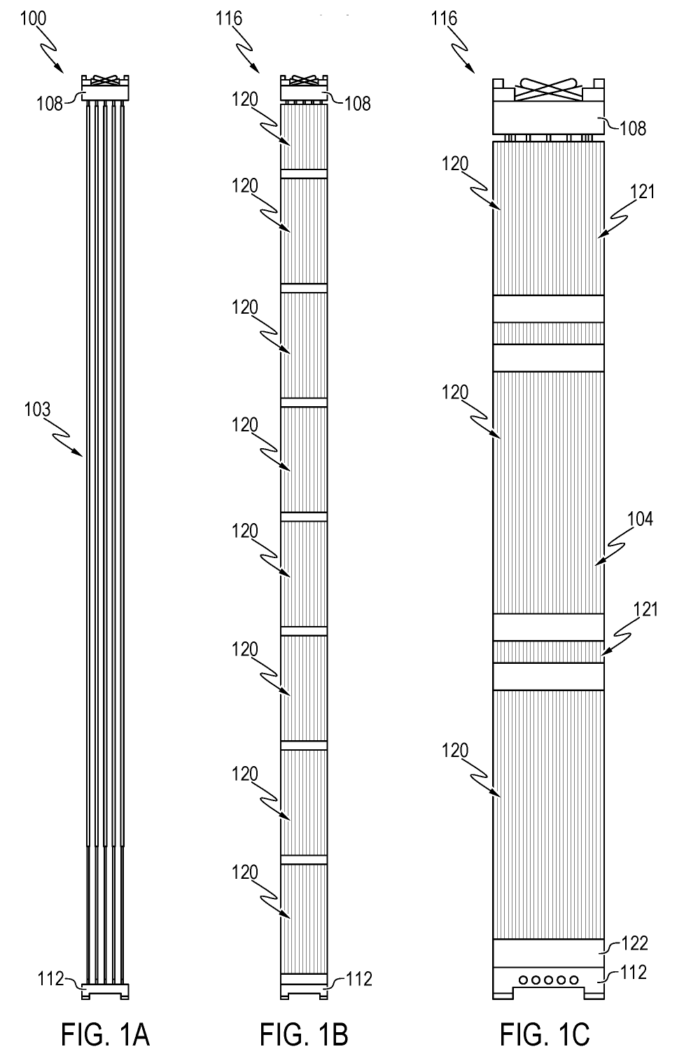

Referring to FIGS. 1A-1C, progressively greater enlargement of features of a fuel assembly are presented from left to right. As shown in FIG. 1A, in a typical geometry of a fuel assembly for a PWR, a plurality of guide thimbles in a guide thimble assembly 103 may extend in parallel, spanning from a top nozzle 108 to a bottom nozzle 112 and forming a fuel assembly skeleton 100. As will be seen more clearly in later figures, each guide thimble may have a circular cross section in a plane perpendicular to the axis of the guide thimble.

The fuel assembly 116 depicted in FIGS. 1B and 1C includes a plurality of stackable fuel blocks. Stackable fuel blocks may mate top to bottom in a complementary manner. Each stackable fuel block is configured to receive the guide thimbles as well as any instrument tubes. Some features are common to all stackable fuel blocks. Other features may be found in only one or some of the stackable fuel blocks. The fuel assembly 116 is comprised of one or more of the following type of stackable fuel blocks: stackable fuel blocks without vanes and without an outer strap (vaneless, strapless fuel blocks 120), stackable fuel blocks with vanes but without an outer strap (vaned, strapless fuel blocks 121), stackable fuel blocks without vanes but with an outer strap (vaneless, strapped fuel blocks 122). Each type of stackable fuel block will be discussed in greater detail below. Each stackable fuel block includes a plurality of fissile material enclosures 104 configured to enclose fissile material.

All the elements of the stackable fuel blocks, with the possible exception of the fuel, that is, the fissile material, form a single first piece of a first material. The first material may include one or more metallic materials such as a zirconium-based material, a FeCrAl-based material, or another appropriate material, where Fe refers to iron, Cr refers to chromium, and Al refers to aluminum.

The fissile material, or fuel, may include all known fuel assembly compositions including one or more of materials in the following list: uranium dioxide (UO₂), UO₂ in a zirconium (Zr) matrix, UₓSi_{y}, UₓSi_{y} in a Zr matrix, UₓN_{y}, UₓN_{y} in a Zr matrix where U is uranium, Si is silicon, N is nitrogen and x and y are integer values. The list of materials further includes alloys U-xMo, UxMo-yZr, U-xNb-yZr, or U-xZr where Mo is molybdenum, Nb is niobium and x and y preceding an element refer to a weight percentage of that element in the alloy.

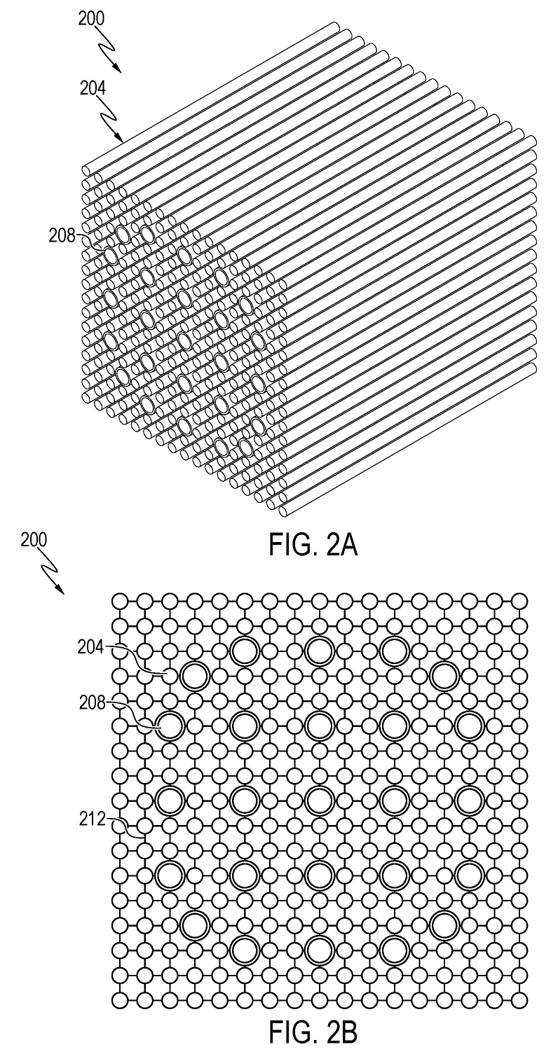

Referring now to FIGS. 2A and 2B, perspective and sectional views, respectively, of a vaneless, strapless fuel block 121 are presented. An array of fissile material enclosures 204 extending parallel to the guide thimbles and instrument tubes that pass through the guide thimble and instrument tube channels 208. Each fissile material enclosure 204 includes a top fuel cap and a bottom fuel cap that complete the fissile material enclosure of fissile material. Enclosure connectors 212 are disposed near the top end or the bottom end of the fissile material enclosures and connect adjacent fissile material enclosures 204. The enclosure connectors may be made from enclosure material and may have a shape of flat or bended strap with thickness of 0.010 to 0.018 inches. The strap height may be in range of 0.010 to 2.000 inches. The strap may have a parabolic cut to mitigate vortex shading effects. As seen in FIG. 2B, each fuel block 121 may present an essentially rectangular cross section perpendicular to the axes of the guide thimble and instrument tube channels 208. In some embodiments, the cross section may be square. In some embodiments, there may be 25 guide thimble and instrument tube channels 208. The cross section may be laid out in a 17 x 17 matrix. There may be 264 fissile material enclosures 204 for holding fissile material. Each fissile material enclosure 204, each guide thimble and instrument tube channel 208, and each enclosure connector 212 may all be formed of a single piece of material using 3D printing.

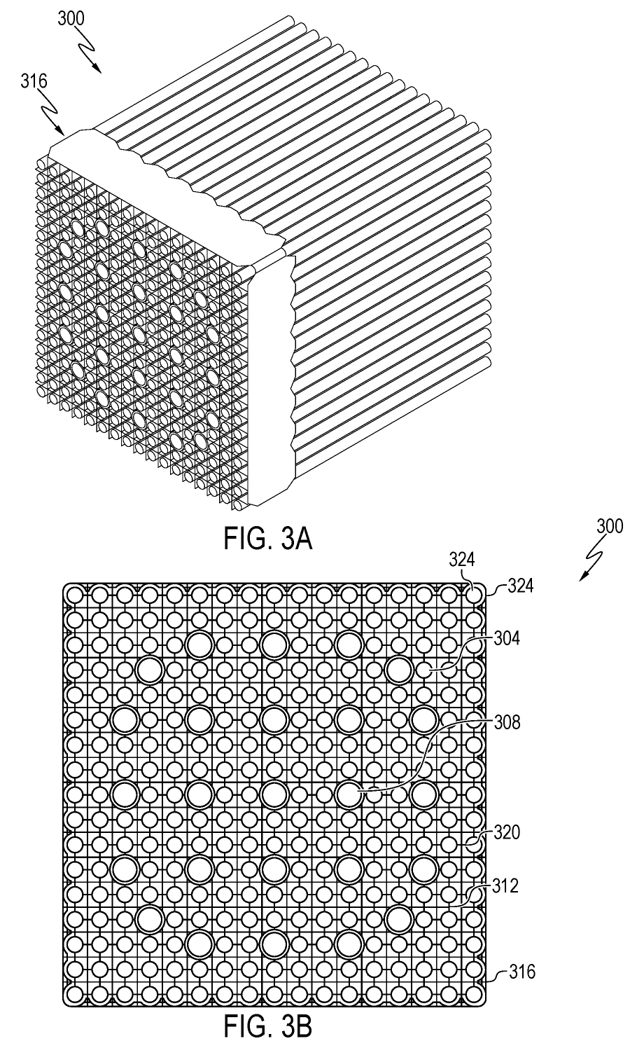

FIGS. 3A and 3B present perspective and sectional views, respectively, of a vaneless, strapped fuel block 300. A vaneless, strapped fuel block 300 includes an array of fissile material enclosures 304, enclosure connectors guide thimble and instrument tube channels 308, and enclosure connectors 312. Similarities previously discussed will not be repeated here. The vaneless, strapped fuel block 300 also includes a crate 320 that includes an outer strap. The crate 320 (including the outer strap 316) is also formed of the single piece of first material. The outer strap 316 of the first piece is formed around the perimeter of the fuel block 300 and extends a portion of a length of the fuel block 300 in an axial direction of the channels. The outer strap 316 connects with a peripheral fuel channel by an enclosure-outer strap connector 324. The crate 320 is formed of the first piece and forms an intersecting rectilinear grid running between and not intersecting the fissile material enclosures 304.

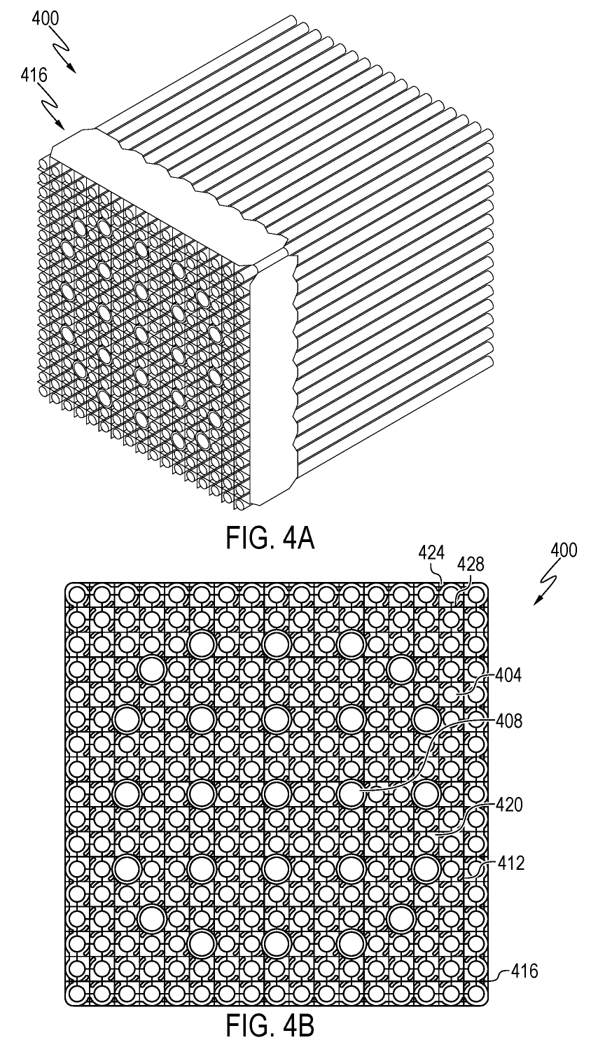

A vaned, strapped fuel block 400, shown in FIGS. 4A and 4B, is similar to the vaneless, strapped fuel block 300, except that vanes 428 are now included. The vaned, strapped fuel block 400 includes an array of fissile material enclosures 404, enclosure connectors guide thimble and instrument tube channels 408, enclosure connectors 412, a crate 420 (including outer strap 416), and the enclosure-outer strap connector 424. Similarities previously discussed will not be repeated here. The vanes 428 provide mixing of the coolant that flows through the stackable fuel blocks. The vanes 428 are formed of the single piece of material using 3D printing.

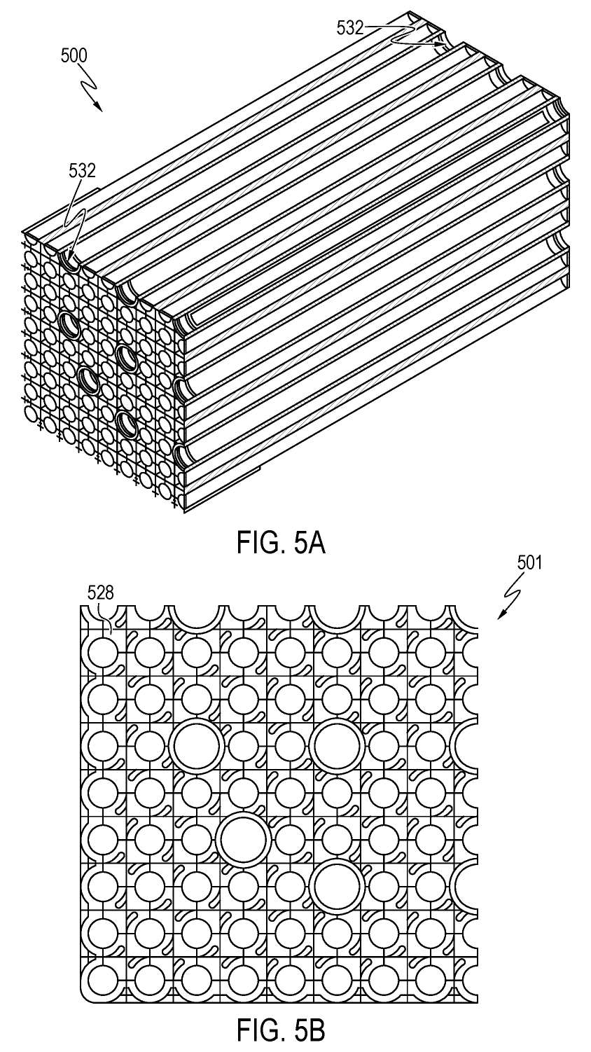

FIG. 5A presents a perspective view of a portion of a stackable fuel block 500. A bulge groove 532 is placed at each end of a guide thimble channel 508 to allow axially-adjacent fuel blocks to be fastened together. FIG. 5B presents another sectional view of a vaned fuel block 501 with vanes (mixing vanes) 528.

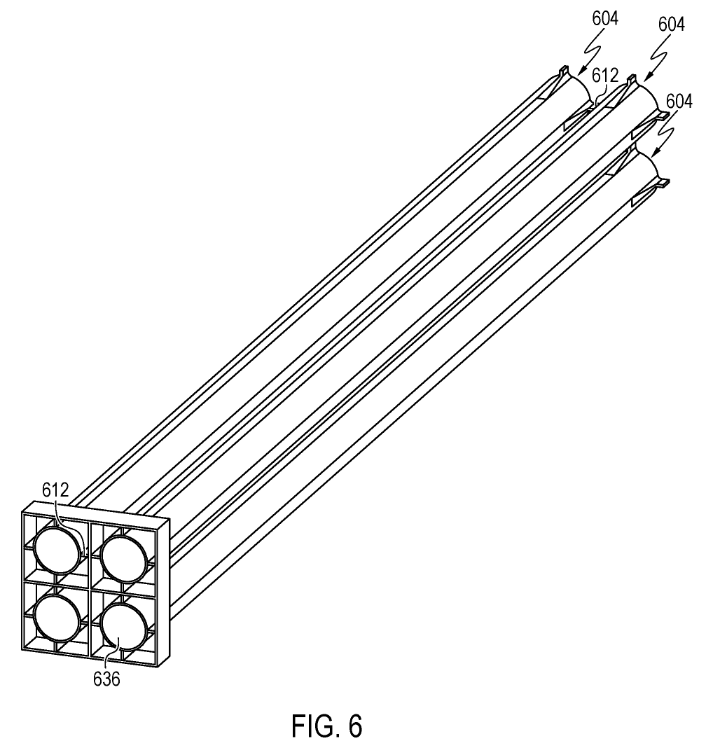

Referring now to FIG. 6, a perspective view on four fissile material enclosures 604 is presented. Each of the fissile material enclosures 604 includes a fuel cap 636 to seal the fissile material in the fissile material enclosure 604. Although FIG. 6 shows only one end of the fissile material enclosures 604, each fissile material enclosure 604 has an fuel cap 636 at the top end and the bottom end of the fissile material enclosure 604. Each fuel cap 636 may be formed of the single piece of first material using 3D printing (that is, AM printing).

FIG. 6 also shows the enclosure connector 612 discussed above that spans between adjacent fissile material enclosures 604.

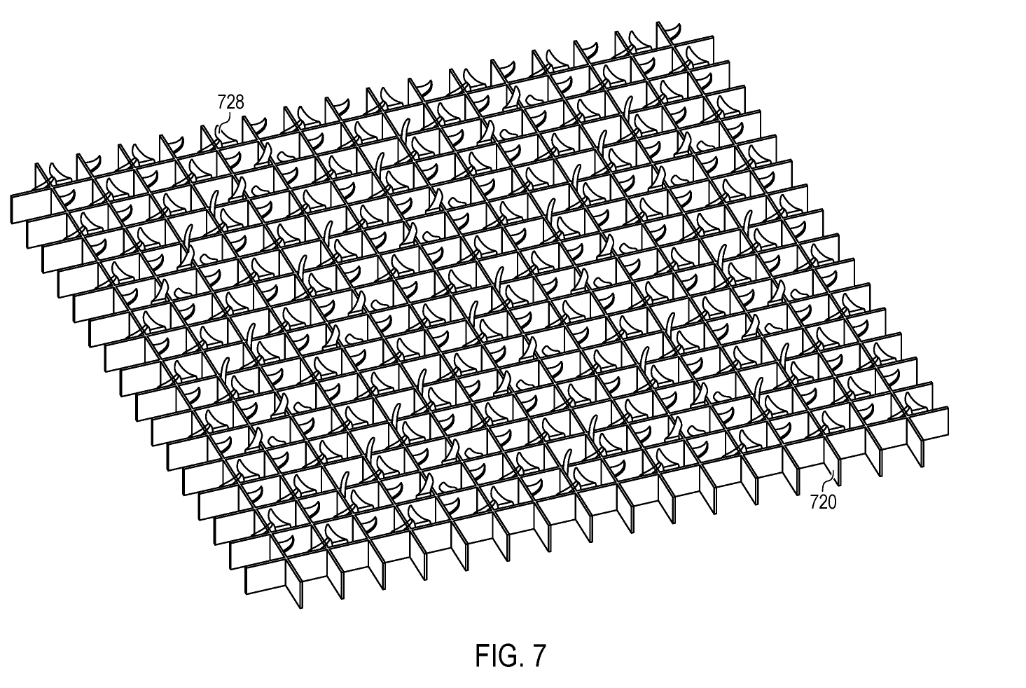

Referring to FIG. 7, a crate 720 is presented in perspective view. Vanes 728 are attached to the crate 720 and provide mixing of the coolant as discussed above. There is one set of vanes 728 per block on the crate 720.

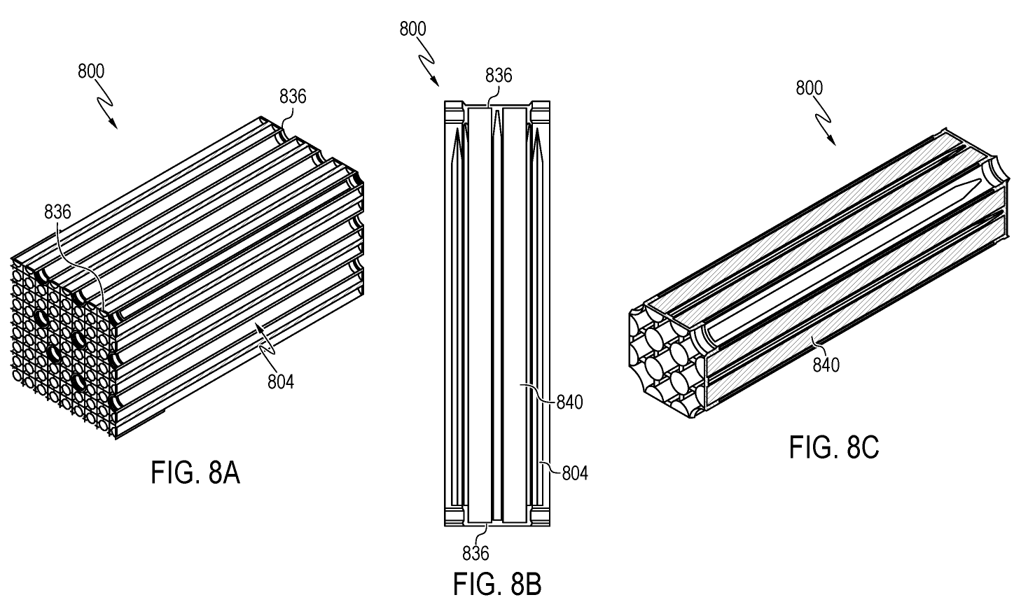

FIGS. 8A-8C present varying perspective views with cutaway on a portion of a stackable fuel block 800. At either end of each fissile material enclosure 804 are fuel caps 836 (top and bottom) as discussed above. Fissile material 840 is shown in the fissile material enclosures 804.

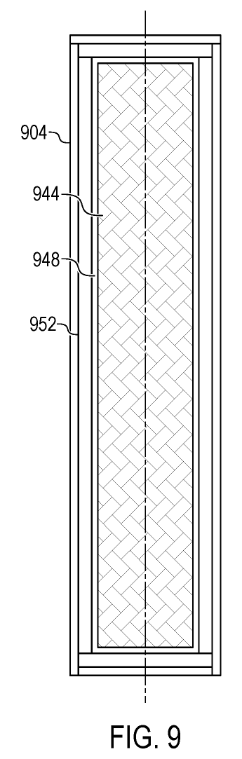

FIG. 9 is a schematic representation of fissile material encapsulated in a fissile material enclosure 904. The fissile material may include a porous core 944. The porous core 944 may be created using 3D printing separately from the 3D printing of the single piece of first material and then inserted into the fissile material enclosure 904 and sealed inside, or the porous core 944 may be 3D printed in conjunction with the 3D printing of the single piece of first material. For the first case, the porous core 944 is surrounded by a perimeter 948 to make a metallurgical contact which allow for structural support of enclosure and effective heat transfer between fissile material and enclosure. For the second case, an enclosure-fissile transition 952 between the perimeter of the porous core 944 and the fissile material enclosure 904 provides a metallurgical contact which allow for structural support of enclosure and effective heat transfer between fissile material and enclosure.

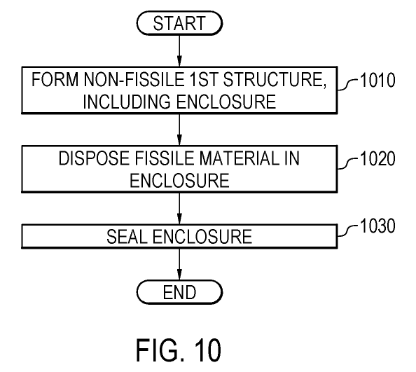

FIG. 10 presents a flowchart describing a method of one or more embodiments of the disclosure. In some embodiments, a method of manufacturing a stackable fuel block includes forming 1010, using three-dimensional (3D) printing, a first structure as a single piece of non-fissile material. That is, the first structure is a unitary piece. The first structure includes the entire stackable fuel block with the exception of the fissile material placed in the fissile material enclosures. The first structure includes a plurality of channels that are configured to receive corresponding guide thimbles and/or instrument tubes; a plurality of fissile material enclosures including a top fuel cap and a bottom fuel cap. At least one fuel cap, for example, the bottom fuel cap, can be created during the process of 3D printing the first structure. The fissile material enclosures are configured to enclose fissile material. In some embodiments, the fissile material is also 3D printed at the same time as the first structure. In such cases, the second fuel cap, for example, the top fuel cap can be included in the 3D printing of the first structure. In embodiments where the fissile material is added to the fissile material enclosures after the 3D printing of the first structure, the top fuel caps can be added by 3D printing or some other suitable manner. In the first structure, the axes of the channels and the axes of the fissile material enclosures may be parallel. The first structure also includes a plurality of enclosure connectors, each enclosure connector disposed near a top end or a bottom end of the fissile material enclosures and connecting adjacent fissile material enclosures. The method also includes disposing 1020 fissile material inside each fissile material enclosure and capping the fissile material enclosure, thus sealing 1030 the fissile material in the fissile material enclosure.

In some embodiments, the first structure and the fissile material may printed at once, that is, part of the same printing process.

In some embodiments, instead of fissile powder, a material with a lower melting temperature than the melting temperature of the enclosure and of the fissile material and with a low parasitic neutron absorption may be used, for example, magnesium. This material (e.g., magnesium) may be installed as a solid and then melted to create a contact between the fissile material and the enclosure.

In some embodiments, disposing fissile material in each fissile material enclosure may include inserting fuel pellets and/or compacts into each fissile material enclosure.

In some embodiments, at least a portion of the fissile material may be a powder. The method may further include after all the fissile material has been disposed in each fissile material enclosure, fusing the powder to an inner wall of each fissile material enclosure by heating the stackable fuel block until the powder melts, creating a transition adjacent to the inner wall. The method may further include forming, using 3D printing, at least a portion of the fissile material into a fissile bar, where the powder is disposed between the fissile bar and the inner wall of the fissile material enclosure. Forming, using 3D printing, at least a portion of the fissile material into a fissile bar may further include creating a porous fissile bar. In some embodiments, disposing fissile material may include 3D printing of fissile material inside each fissile material enclosure in conjunction with 3D printing of the first structure.

In some embodiments, forming the first structure further includes forming an outer strap of the single piece around a perimeter of the vaneless fuel block, the outer strap extending a portion of a length of the vaneless fuel block in an axial direction of the channels, and connecting with a peripheral fissile material enclosure by a enclosure-outer strap connector. Forming the first structure may also include forming a crate of the single piece creating an intersecting rectilinear grid running between and not intersecting the fissile material enclosures.

Forming the first structure may further include forming a plurality of mixing vanes, each mixing vane formed of the single piece, disposed on the crate, and not touching the fissile material enclosures. Forming the first structure may further include forming an outer strap of the single piece around a perimeter of the vaned fuel block, extending a portion of a length of the fuel block with an outer strap in the axial direction of the channels, connecting with a peripheral fissile material enclosure by an enclosure-outer strap connector, and connecting to the crate.

Example 1 – a method of manufacturing a stackable fuel block, the method including: forming, using three-dimensional (3D) printing, a first structure as a single piece of non-fissile material, wherein forming the first structure comprises: forming, using the 3D printing, a plurality of channels configured to receive guide thimbles and/or instrument tubes; forming, using the 3D printing, a plurality of fissile material enclosures including a top fuel cap and a bottom fuel cap, wherein the fissile material enclosures are configured to enclose fissile material; and forming, using the 3D printing, a plurality of enclosure connectors, each enclosure connector extending between adjacent fissile material enclosures. The method may further include disposing fissile material inside the plurality of fissile material enclosures.

Example 2 – The method of Example 1, wherein disposing the fissile material in the plurality of fissile material enclosures comprises inserting fuel pellets and/or compacts into each fissile material enclosure.

Example 3 - The method of Example 1 or Example 2, wherein at least a portion of the fissile material is a powder, the method further comprising, after all the fissile material has been disposed in each fissile material enclosure, fusing the powder to an inner wall of each fissile material enclosure by heating until the powder melts, creating a transition adjacent to the inner wall.

Example 4 - The method of any of the previous examples, wherein at least a portion of the fissile material is a powder, wherein the method further comprises: forming, using the 3D printing, at least a portion of the fissile material into a fissile bar; and disposing the power between the fissile bar and an inner wall of the fissile material enclosure.

Example 5 - The method of Example 4, wherein forming the portion of the fissile material into the fissile bar comprises forming a porous fissile bar.

Example 6 - The method of any of the previous examples, wherein disposing fissile material comprises 3D printing of fissile material inside each fissile material enclosure in conjunction with 3D printing of the first structure.

Example 7 - The method of any of the previous examples, wherein disposing fissile material comprises: pausing the forming, using the 3D printing, of the first structure before sealing the fissile material enclosures; inserting the fissile material into the fissile material enclosures; and resuming the forming, using the 3D printing, of the first structure.

Example 8 - The method of any of the previous examples, wherein forming the first structure further comprises: forming, using the 3D printing, an outer strap of the single piece around a perimeter of a stackable fuel block, the outer strap extending a portion of a length of the fuel block in an axial direction of the channels, and connecting with a peripheral fissile material enclosure by an enclosure-outer strap connector; and forming, using the 3D printing, a crate of the single piece creating an intersecting grid running between and not intersecting the fissile material enclosures.

Example 9 - The method of Example 8, wherein forming the first structure further comprises: forming, using the 3D printing, a plurality of mixing vanes, each mixing vane formed of the single piece, disposed on the crate.

Example 10 - The method of any of the previous examples, wherein each enclosure connector is disposed near a top end or a bottom end of fissile material enclosures.

Example 11 - The method of any of the previous examples, wherein forming the first structure comprises 3D printing the first structure with an essentially rectangular cross section perpendicular to the axes of the channels.

Example 12 - A fuel assembly comprising a plurality of stackable fuel blocks, each fuel block comprising: a 3D-printed single piece comprising a first material, the 3D-printed single piece further comprising: a plurality of 3D-printed channels configured to receive guide thimbles and/or instrument tubes; a plurality of 3D-printed fissile material enclosures including a top fuel cap and a bottom fuel cap and configured to enclose fissile material; and a plurality of 3D-printed enclosure connectors, each 3D-printed enclosure connector disposed at a top end or a bottom end of the 3D-printed fissile material enclosures and connecting adjacent 3D-printed fissile material enclosures. Each fuel block further comprising the fissile material disposed in each fissile material enclosure, each of the plurality of stackable fuel blocks being stackable with another stackable fuel block top to bottom in a complementary manner.

Example 13 - The fuel assembly of Example 12, wherein at least one fuel block further comprises the 3D-printed single piece of the fuel block, the 3D-printed single piece further comprising: a 3D-printed outer strap of the 3D-printed single piece, the 3D-printed outer strap formed around a perimeter of the fuel block, extending a portion of a length of the fuel block in an axial direction of the 3D-printed channels, and connecting with a peripheral 3D-printed fissile material enclosure by a 3D-printed enclosure-outer strap connector; and a 3D-printed crate formed of the 3D-printed single piece forming an intersecting rectilinear grid running between and not intersecting the 3D-printed fissile material enclosures.

Example 14 - The fuel assembly of Example 12 or Example 13, wherein at least one fuel block further comprises the single piece of the fuel block, the single piece further comprising: a plurality of 3D-printed mixing vanes, each mixing vane formed of the 3D-printed single piece, disposed on the 3D-printed crate.

Example 15 - The fuel assembly of any of Examples 12-14, wherein: a top stackable fuel block further comprises a top nozzle, and a bottom stackable fuel block further comprises a bottom nozzle.

Example 16 - The fuel assembly of any of Examples 12-15, wherein the fissile material is fused onto an inner wall of each 3D-printed fissile material enclosure, and wherein the fissile material comprises a porous core surrounded by a perimeter impermeable to fission gas and spanning from the porous core to the inner wall of each 3D-printed fissile material enclosure, wherein, when the plurality of 3D-printed fissile material enclosures and the fissile material are printed at the same time, a transition zone exists between each 3D-printed fissile material enclosure and the fissile material disposed in each fissile material enclosure, and wherein, when the plurality of 3D-printed fissile material enclosures and the fissile material are printed separately and then connected, either fissile material powder or non-fissile material creates a metallurgical contact between each 3D-printed fissile material enclosure and the fissile material disposed in each fissile mater enclosure.

Example 17 - The fuel assembly of any of Examples 12-16, wherein each stackable fuel block extends no more than one foot in the axial direction.

Example 18 - The fuel assembly of any of Examples 12-17, wherein the fuel assembly extends 12 to 14 feet in the axial direction.

Example 19 - The fuel assembly of any of Examples 12-18, wherein the first material comprises at least one of a zirconium-based or FeCrAl-based material

Example 20 - The fuel assembly of any of Examples 12-19, wherein the fissile material comprises at least one of UO2, UO2 in a Zr matrix, UxSiy, UxSiy in a Zr matrix, UxNy, UxNy in a Zr matrix, U-xMo, UxMo-yZr, U-xNb-yZr, or U-xZr.

Example 21 - The fuel assembly of any of Examples 12-20, wherein a porosity of the porous core is greater than or equal to 5% to less than or equal to 50%.

Example 22 - The fuel assembly of Example 21, wherein the porous core is repeatable three-dimensional pattern created by 3D printing.

Example 23 - The fuel assembly of Claim 12, wherein the fissile material comprises uranium and the uranium enrichment is less than 20%.

Example 24 - The fuel assembly of any of Examples 12-23, wherein the 3D-printed enclosure connectors are less than 0.018 inches thick.

Example 25 - The fuel assembly of any of Examples 12-24, wherein each stackable fuel block comprises: 14x14 179 3D-printed fissile material enclosures and 17 3D-printed channels, wherein an outer diameter of the enclosure is .442 inch, and a pitch of the fissile material is .556 inch located in square lattice; 14x14 179 3D-printed fissile material enclosures and 17 3D-printed channels, wherein an outer diameter of the enclosure is .442 inch, and a pitch of the fissile material is .556 inch located in square lattice; 15x15 204 3D-printed fissile material enclosures and 21 3D-printed channels, wherein an outer diameter of the enclosure is .442 inch, and a pitch of the fissile material is .563 inch located in square lattice; 16x16 235 3D-printed fissile material enclosures and 21 3D-printed channels, wherein an outer diameter of the enclosure is .485 inch, and a pitch of the fissile material is .360 inch located in square lattice; 16x16 235 3D-printed fissile material enclosures and 21 3D-printed channels, wherein an outer diameter of the enclosure is .485 inch, and a pitch of the fissile material is .374 inch located in square lattice; 17x17 264 (number) 3D-printed fissile material enclosures and 25 3D-printed channels, wherein an outer diameter of the enclosure is .496 inch, and a pitch of the fissile material is .360 inch located in square lattice; or 17x17 264 (number) 3D-printed fissile material enclosures and 25 3D-printed channels, wherein an outer diameter of the enclosure is .496 inch, and a pitch of the fissile material is .374 inch located in square lattice.

All patents, patent applications, publications, or other disclosure material mentioned herein, are hereby incorporated by reference in their entirety as if each individual reference was expressly incorporated by reference respectively. All references, and any material, or portion thereof, that are said to be incorporated by reference herein are incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference and the disclosure expressly set forth in the present application controls.

The present disclosure has been described with reference to various exemplary and illustrative aspects. The aspects described herein are understood as providing illustrative features of varying detail of various aspects of the disclosed disclosure; and therefore, unless otherwise specified, it is to be understood that, to the extent possible, one or more features, elements, components, constituents, ingredients, structures, modules, and/or aspects of the disclosed aspects may be combined, separated, interchanged, and/or rearranged with or relative to one or more other features, elements, components, constituents, ingredients, structures, modules, and/or aspects of the disclosed aspects without departing from the scope of the disclosed disclosure. Accordingly, it will be recognized by persons having ordinary skill in the art that various substitutions, modifications or combinations of any of the exemplary aspects may be made without departing from the scope of the disclosure. In addition, persons skilled in the art will recognize, or be able to ascertain using no more than routine experimentation, many equivalents to the various aspects of the disclosure described herein upon review of this specification. Thus, the disclosure is not limited by the description of the various aspects, but rather by the claims.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although claim recitations are presented in a sequence(s), it should be understood that the various operations may be performed in other orders than those which are described, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Directional phrases used herein, such as, for example and without limitation, top, bottom, left, right, lower, upper, front, back, and variations thereof, shall relate to the orientation of the elements shown in the accompanying drawing and are not limiting upon the claims unless otherwise expressly stated.

The terms “about” or “approximately” as used in the present disclosure, unless otherwise specified, means an acceptable error for a particular value as determined by one of ordinary skill in the art, which depends in part on how the value is measured or determined. In certain aspects, the term “about” or “approximately” means within 1, 2, 3, or 4 standard deviations. In certain aspects, the term “about” or “approximately” means within 50%, 200%, 105%, 100%, 9%, 8%, 7%, 6%, 5%, 4%, 3%, 2%, 1%, 0.5%, or 0.05% of a given value or range.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Any numerical range recited herein includes all sub-ranges subsumed within the recited range. For example, a range of “1 to 100” includes all sub-ranges between (and including) the recited minimum value of 1 and the recited maximum value of 100, that is, having a minimum value equal to or greater than 1 and a maximum value equal to or less than 100. Also, all ranges recited herein are inclusive of the end points of the recited ranges. For example, a range of “1 to 100” includes the end points 1 and 100. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The terms "comprise" (and any form of comprise, such as "comprises" and "comprising"), "have" (and any form of have, such as "has" and "having"), "include" (and any form of include, such as "includes" and "including") and "contain" (and any form of contain, such as "contains" and "containing") are open-ended linking verbs. As a result, a system that "comprises," "has," "includes" or "contains" one or more elements possesses those one or more elements, but is not limited to possessing only those one or more elements. Likewise, an element of a system, device, or apparatus that "comprises," "has," "includes" or "contains" one or more features possesses those one or more features, but is not limited to possessing only those one or more features.

What is claimed is:

1. A method of manufacturing a stackable fuel block, the method comprising:
forming, using three-dimensional (3D) printing, a first structure as a single piece of non-fissile material, wherein forming the first structure comprises:
forming, using the 3D printing, a plurality of channels configured to receive guide thimbles and/or instrument tubes;
forming, using the 3D printing, a plurality of fissile material enclosures including a top fuel cap and a bottom fuel cap, wherein the fissile material enclosures are configured to enclose fissile material; and
forming, using the 3D printing, a plurality of enclosure connectors, each enclosure connector extending between adjacent fissile material enclosures; and
disposing fissile material inside the plurality of fissile material enclosures.

2. The method of claim 1, wherein disposing the fissile material in the plurality of fissile material enclosures comprises inserting fuel pellets and/or compacts into each fissile material enclosure.

3. The method of claim 1, wherein at least a portion of the fissile material is a powder,
the method further comprising, after all the fissile material has been disposed in each fissile material enclosure, fusing the powder to an inner wall of each fissile material enclosure by heating until the powder melts, creating a transition adjacent to the inner wall.

4. The method of claim 1, wherein at least a portion of the fissile material is a powder, wherein the method further comprises:
forming, using the 3D printing, at least a portion of the fissile material into a fissile bar; and
disposing the power between the fissile bar and an inner wall of the fissile material enclosure.

5. The method of claim 4, wherein forming the portion of the fissile material into the fissile bar comprises forming a porous fissile bar.

6. The method of claim 1, wherein disposing fissile material comprises 3D printing of fissile material inside each fissile material enclosure in conjunction with 3D printing of the first structure.

7. The method of claim 1, wherein disposing fissile material comprises:
pausing the forming, using the 3D printing, of the first structure before sealing the fissile material enclosures;
inserting the fissile material into the fissile material enclosures; and
resuming the forming, using the 3D printing, of the first structure.

8. The method of claim 1, wherein forming the first structure further comprises:
forming, using the 3D printing, an outer strap of the single piece around a perimeter of a stackable fuel block, the outer strap extending a portion of a length of the fuel block in an axial direction of the channels, and connecting with a peripheral fissile material enclosure by an enclosure-outer strap connector; and
forming, using the 3D printing, a crate of the single piece creating an intersecting grid running between and not intersecting the fissile material enclosures.

9. The method of claim 8, wherein forming the first structure further comprises:
forming, using the 3D printing, a plurality of mixing vanes, each mixing vane formed of the single piece, disposed on the crate.

10. The method of claim 1, wherein each enclosure connector is disposed near a top end or a bottom end of fissile material enclosures.

11. The method of claim 1, wherein forming the first structure comprises 3D printing the first structure with an essentially rectangular cross section perpendicular to the axes of the channels.

12. A fuel assembly comprising a plurality of stackable fuel blocks,
each fuel block comprising:
a 3D-printed single piece comprising a first material, the 3D-printed single piece further comprising:
a plurality of 3D-printed channels configured to receive guide thimbles and/or instrument tubes;
a plurality of 3D-printed fissile material enclosures including a top fuel cap and a bottom fuel cap and configured to enclose fissile material; and
a plurality of 3D-printed enclosure connectors, each 3D-printed enclosure connector disposed at a top end or a bottom end of the 3D-printed fissile material enclosures and connecting adjacent 3D-printed fissile material enclosures; and
the fissile material disposed in each fissile material enclosure,
each of the plurality of stackable fuel blocks being stackable with another stackable fuel block top to bottom in a complementary manner.

13. The fuel assembly of claim 12, wherein at least one fuel block further comprises the 3D-printed single piece of the fuel block, the 3D-printed single piece further comprising:
a 3D-printed outer strap of the 3D-printed single piece, extending a portion of a length of the fuel block in an axial direction of the 3D-printed channels, and connecting with a peripheral 3D-printed fissile material enclosure by a 3D-printed enclosure-outer strap connector; and
a 3D-printed crate formed of the 3D-printed single piece forming an intersecting rectilinear grid running between and not intersecting the 3D-printed fissile material enclosures.

14. The fuel assembly of claim 12, wherein at least one fuel block further comprises the single piece of the fuel block, the single piece further comprising:
a plurality of 3D-printed mixing vanes, each mixing vane formed of the 3D-printed single piece, disposed on the 3D-printed crate.

15. The fuel assembly of claim 12, wherein:
a top stackable fuel block further comprises a top nozzle, and
a bottom stackable fuel block further comprises a bottom nozzle.

16. The fuel assembly of claim 12, wherein the fissile material is fused onto an inner wall of each 3D-printed fissile material enclosure, and
wherein the fissile material comprises a porous core surrounded by a perimeter impermeable to fission gas and spanning from the porous core to the inner wall of each 3D-printed fissile material enclosure,
wherein, when the plurality of 3D-printed fissile material enclosures and the fissile material are printed at the same time, a transition zone exists between each 3D-printed fissile material enclosure and the fissile material disposed in each fissile material enclosure, and
wherein, when the plurality of 3D-printed fissile material enclosures and the fissile material are printed separately and then connected, either fissile material powder or non-fissile material creates a metallurgical contact between each 3D-printed fissile material enclosure and the fissile material disposed in each fissile mater enclosure.

17. The fuel assembly of claim 12, wherein each stackable fuel block extends no more than one foot in the axial direction.

18. The fuel assembly of claim 12, wherein the fuel assembly extends 12 to 14 feet in the axial direction.

19. The fuel assembly of claim 12, wherein the first material comprises at least one of a zirconium-based or FeCrAl-based material.

20. The fuel assembly of claim 12, wherein the fissile material comprises at least one of UO_{2,} UO₂ in a Zr matrix, UₓSi_{y,} UₓSi_{y} in a Zr matrix, UₓN_{y,} UₓN_{y} in a Zr matrix, U-xMo, UxMo-yZr, U-xNb-yZr, or U-xZr.

21. The fuel assembly of claim 16, wherein a porosity of the porous core is greater than or equal to 5% to less than or equal to 50%.

22. The fuel assembly of claim 21, wherein the porous core is repeatable three-dimensional pattern created by 3D printing.

23. The fuel assembly of claim 12, wherein the fissile material comprises uranium and the uranium enrichment is less than 20%.

24. The fuel assembly of claim 12, wherein the 3D-printed enclosure connectors are less than 0.018 inches thick.

25. The fuel assembly of claim 12, wherein each stackable fuel block comprises:
14x14 179 3D-printed fissile material enclosures and 17 3D-printed channels, wherein an outer diameter of the enclosure is .442 inch, and a pitch of the fissile material is .556 inch located in square lattice;
14x14 179 3D-printed fissile material enclosures and 17 3D-printed channels, wherein an outer diameter of the enclosure is .442 inch, and a pitch of the fissile material is .556 inch located in square lattice;
15x15 204 3D-printed fissile material enclosures and 21 3D-printed channels, wherein an outer diameter of the enclosure is .442 inch, and a pitch of the fissile material is .563 inch located in square lattice;
16x16 235 3D-printed fissile material enclosures and 21 3D-printed channels, wherein an outer diameter of the enclosure is .485 inch, and a pitch of the fissile material is .360 inch located in square lattice;
16x16 235 3D-printed fissile material enclosures and 21 3D-printed channels, wherein an outer diameter of the enclosure is .485 inch, and a pitch of the fissile material is .374 inch located in square lattice;
17x17 264 (number) 3D-printed fissile material enclosures and 25 3D-printed channels, wherein an outer diameter of the enclosure is .496 inch, and a pitch of the fissile material is .360 inch located in square lattice; or
17x17 264 (number) 3D-printed fissile material enclosures and 25 3D-printed channels, wherein an outer diameter of the enclosure is .496 inch, and a pitch of the fissile material is .374 inch located in square lattice.
